(19) United States
(12) Patent Application Publication
(10) Pub. No.: US 2013/0196084 A1
(43) Pub. Date: Aug. 1, 2013

(54) Process for the Production of a Nanomaterial and Reactor for Implementing it

(71) Applicants: Gero Decher, Kehl-Marlen (DE); Olivier Felix, Holtzheim (FR); Emek Seyrek, Lingolsheim (FR); Rafael Szamocki, Quatzeinheim (FR); Gabriela Popa, Strasbourg (FR); Rita El-Khouri, Morristown, NJ (US)

(72) Inventors: Gero Decher, Kehl-Marlen (DE); Olivier Felix, Holtzheim (FR); Emek Seyrek, Lingolsheim (FR); Rafael Szamocki, Quatzeinheim (FR); Gabriela Popa, Strasbourg (FR); Rita El-Khouri, Morristown, NJ (US)

(73) Assignees: UNIVERSITE DE STRASBOURG, Strasbourg (FR); CENTRE NATIONAL DE LA RECHERCHE SCIENTIFIQUE, Paris (FR)

(21) Appl. No.: 13/699,017

(22) PCT Filed: May 20, 2011
(86) PCT No.: PCT/EP2011/058289

§ 371 Date: Feb. 11, 2013

(30) Foreign Application Priority Data
May 21, 2010 (FR) 1053978

(51) Int. Cl. B05D 1/02; B05B 7/00

(52) U.S. Cl. CPC B05D 1/02; B05B 7/00
USPC 427/600; 427/426; 118/315

(57) ABSTRACT

The present invention relates to a novel process for synthesizing nanomaterials by mixing liquids in a quasi-2D microfluidic reactor. The invention also relates to the reactor for implementing this process.

The present invention relates to a new method for synthesizing nanometric objects by mixing liquids in a quasi-2D microfluidic reactor.

Chemistry is a natural science, divided into several specialties. The aim of all these specialties is to study and control the composition and transformation of matter.

Matter can be transformed by many chemical processes—chemical reactions, complex formation, crystal nucleation, emulsion formation, etc., which may be done by mixing two solutions containing one or more reactants. Thus, mixing liquid is undoubtedly one of the most fundamental techniques in chemistry. However, this technique is more complicated than it appears. Indeed, even the way solutions are mixed can influence the reactions that occur within them. For example, when the reaction rates are slow in comparison to the mixing speed, the mixing method has a negligible influence on the reaction. However, in so-called fast reactions, the mixing method becomes critical in order to control chemical processes. Consequently, fast continuous mixing of liquids, such as is the case in “stopped flow” reactors, which constitutes an optimized method for mixing small quantities of liquid in a few milliseconds, has become a hot topic in many fields of chemistry (see, for example, “Reaction in Droplets in Microfluidic Channels”, Helen Song, Delai L. Chen, and Rustem F. Ismagilov, Angew. Chem. Int. Ed. 2006, 45, 7336-7356).

Liquid mixing also faces problems with the solubility of the products obtained. Indeed, quickly and homogenously mixing several solutions together becomes more difficult the more insoluble the reaction products are in the medium, or if phase separation arises. Thus, a mixing step can succeed in determining the nature and/or properties of the products of the reaction (see, for example, “National Research Council, Beyond the Molecular Frontier: Challenges for Chemistry and Chemical Engineering”, The National Academic Press, Washington, D.C., 2003, pages 36-40). Typical examples include the formation of complexes between polyelectrolytes of different charges (for example DNA/polycation complexes, which are important in gene transfection) or the synthesis of some nanoparticles (for example nano-hydroxyapatite, which appears interesting in the stimulation of bone or cartilage growth). This also involves more complex materials, such as the nanoparticles called “nano-bags” made up, for example, of polycations/citrates that have been recently described “From ‘Nano-bags’ to ‘Micro-pouches’. Understanding and Tweaking Flocculation-Based Methods for the Preparation of New Nanoparticle-Composites”, Gregory F. Schneider and Gero Decher, Nano Lett., 2008, 8 (11), pages 3598-3604).

Thus, the mixing method is crucial to control the properties of the materials produced in all cases where an initial precipitation phase, a separation phase and a phase where nucleation/germination occurs more quickly than the time necessary to obtain a homogenous mixture by mixing.

Moreover, even the order of adding the solutions can have an impact on the progress of the reaction. Indeed, injecting solution A into solution B (Case I) can lead to a different result than that of injecting solution B into solution A (Case II). This is the well-known example of adding water to a concentrated acid solution (sulfuric acid or hydrochloric acid, for example) whose reaction may be violent. Indeed, it is well known that it is better to add the acid to the water solution.

Furthermore, additional effects may appear according to the intensity and type of stirring, simply due to an initial local excess of B compared to A (Case I) or an initial local excess of A compared to B (Case II).

Modern chemical reactors, with optimized designs, can help, in certain cases, to better control such chemical processes, but only in a very limited range of parameter control.

Moreover, and even in homogenous chemical reactions, mixing can influence all the reactions benefiting from an excess of one reactant compared to the other, or reactions that are preferred at specific concentrations (cyclization vs. polymerization). These phenomena are amplified in the case of so-called “batch” sample reactions. However, note that the chemical processes targeted by the present invention are mainly heterogeneous chemical reactions and processes.

A recent interesting alternative for controlling difficult reactions is so-called microfluidic technology. This technology, or discipline, deals with the behavior, precise control and manipulation of fluids that are geometrically confined, typically at the sub-millimeter scale. This technology has created a real revolution in chemistry, enabling many improvements in how chemical reactions are implemented, for example, allowing the production of emulsions with emulsion droplets almost completely monodispersed, or nucleation phenomena, encapsulations of living cells, or even the integration of whole miniaturized reaction chains on “labs on a chip”. Journals showing the enormous potential of microfluidic technology are now abundant in the literature. For this reason, this technology will not be described in great detail in this application.

However, current conventional microfluidic reactors are limited by production throughput. The conventional throughput by microfluidic technology is limited to around 5 mL/hour. This limitation has led to other developments, such as massively parallel microfluidic technology. However, it is clear that despite these developments, mass production of products remains difficult to do and production costs are still high.

The reactor described in this application is a quasi-2D microfluidic reactor.

Two solutions are sprayed in a synchronous manner onto a solid surface, thus forming a thin liquid film (see FIG. 1). The key element of the invention is found in the formation of this film by this technique. The jets reach the solid surface at the same time, allowing controlled mixing: the droplets arriving at the liquid and/or substrate merge to form the film and thus produce an area of extremely homogenous mixing. The interest of the present invention lies in the use of small droplets and a thin liquid film to allow fast mixing of the reaction partners in the liquid film by fast diffusion (the diffusion and mixing rate are inversely dependent on the size of the droplets and the thickness of the liquid film).

The merging of the individual droplets with the liquid film leads to a fast mixing of the solutions containing the reaction partners in the liquid film. Thus, the present invention continuously renews the liquid film.

The present invention allows dramatically reducing the macroscopic concentration gradients during continuous mixing of at least two liquids.

Moreover, it is possible to create an intentional concentration gradient by offsetting the jets (without masking).

The reactor of the present invention has the advantage of continuously producing a high flow rate of liquid films in which the reactions occur. The thickness of the film obtained at the surface of the solid substrate is controlled by the spraying characteristics (for example, the flow rates of the air/solutions applied, or, for example, the flow rate of the solutions/frequency and/or amplitude by the use of ultrasound in cases of spraying with an ultrasound nozzle), and by the nature of the solid surface (roughness, contact angle, etc.). It is also possible to recover the liquid evacuated by draining from the solid surface, said liquid being able to be a suspension of polyelectrolyte complexes, inorganic precipitates, etc., as well as the nanomaterials that said liquid contains. Depending on the pumps and nozzles, a reactor with a diameter of 10 cm with a single liquid allows using routine reaction volumes between 50 μL and 100 mL per minute. In comparison with conventional microfluidic reactors, even reactors of simple design according to the present invention allow throughputs 10³ to 10⁶ times greater than conventional channel microfluidic reactors according to the dimensions of the jets sprayed, the size of the 2D substrate and the density of droplets sprayed.

Another advantage of the reactor of the present invention is the possibility of precisely adjusting in a broad range the stoichiometry of the two (or more) reactants by simply controlling the flow rate of each nozzle. Drainage of the liquid is not limited by any constraint whatever since the reactor can be completely open. This opening is a technical criterion that clearly sets the reactor of the present invention apart from closed channel microfluidic technology, in which the maximum throughput is limited by the diameter of the channels. Moreover, in view of the simplicity of implementation of the method of the present invention, it is possible in special reaction cases to easily work in controlled atmosphere (see Example 6).

Thus the reactor of this invention is extremely simple to produce and implement. Such a reactor allows a high degree of optimization of synthesis for a large variety of nanomaterials, aggregates and small composite materials. Moreover, the fact that the liquid reaches the 2D surface by the third dimension easily allows modulating the reactor according to the different applications.

### SUMMARY OF THE INVENTION

The subject of the invention is a method for producing nanometric to micrometric size material from at least two reaction partners. The subject of the invention involves simultaneously spraying at least two clouds of droplets of micrometric or nanometric size each containing one of said reaction partners that are precursors of said material or a mixture thereof, through nozzles convergent in the direction of a solid surface on which is formed, by overlay of sprayed liquid jets, a homogenous liquid reaction zone in the form of a film of controlled thickness comprised between 0.1 μm and 100 μm inside of which the reaction mainly occurs leading to said nanoscale material.

Another subject of the present invention concerns a reactor for the production of nanoscale materials conforming to the method according to the invention. This reactor comprises at least two sprayers, each fed by a liquid, and whose spray nozzles converge in the direction of a plate intercepting the sprayed liquid reactant jets, and in that the arrangement of the sprayers with regard to each other and to said plate is such that the sprayed liquid reactant jets completely or partially overlap on the surface of said plate to form a liquid reaction zone in the form of a homogenous film of controlled thickness, preferentially operating continuously.

### DEFINITIONS

A “nanoscale material” is a material which has at least one homogenous element having a dimension, called thickness, that ranges between one nanometer and several hundred nanometers, or even several thousand nanometers, and which allows it to acquire special properties.

“Reaction partners” means any type of chemical entity, atom or molecule, that can bind another chemical entity, atom or molecule, identical or different, optionally dissolved in one or more solvents.

“Solvent” according to the present invention means any product or substance that allows the dissolution of another product. Moreover, it is possible for the solvent molecules to participate in the structure of the thin layer. It is possible to vary the viscosity of the solvent in order to modulate the spray characteristics (size of the droplets, drainage rate, reaction speed, etc.). For example, the addition of neutral polymers (i.e., not reacting with the reaction partners) in the solvent can increase the viscosity of the solvent.

The word “spray” according to this invention concerns the production of a cloud of droplets, i.e., containing micro or nanoscale droplets, liquids and/or solids, suspended in the gas containing them and which optionally carries them or the space that contains them. This moving cloud of droplets will be defined as a spray jet or “spray”. This spray jet can have any form (solid cone, hollow cone (particles are only present at the periphery of the cone, for example), linear, etc.). The spray is obtained by a sprayer, which can be an atomizer or any other device well known to the person skilled in the art. Advantageously, this sprayer consists of at least one nozzle for liquid outlet that allows suspending said liquid in the form of droplets in a carrier gas or in the atmosphere (environmental gas). Any type of nozzle that permits spraying is usable. The word “nozzle” therefore refers to the device producing a droplet cloud.

“Solid surface” means the surface of a solid body, i.e., a solid body, or object, fairly firm and rigid to support the spray jets that are applied to it without deformation of said object, which would impede the realization of the invention.

The word “simultaneous” implies that there are several sprayers acting at the same time on a same substrate.

“Convergent nozzles” means that the spray nozzles are arranged so that the spray jets coming from said nozzles or the droplet clouds coming from the spray or sprays overlap over at least a part of the volume occupied by the droplet clouds before deposit on the substrate surface.

The word “film” is well known to the person skilled in the art. This word refers to a 2D liquid coating on the solid surface. The thickness of the coating can be comprised between around ten nanometers and several hundred micrometers. Advantageously, the method according to the invention permits obtaining a film with a thickness of 0.1 μm to 100 μm.

A reactor is the 2D liquid film on the surface according to the present invention, suitable to the realization and optimization of chemical reactions and more generally matter transformation processes according to the present invention.

“Mainly” means that all or part of the chemical reaction occurs in the film of controlled thickness. Advantageously, the number of moles of deficit reactant reacting in the film of controlled thickness is between 50% and 100%, more preferably between 70% and 100%, even more preferably between 80% and 100%, more advantageously still between 90% and 100%. Preferably, the chemical reaction occurs essentially in the controlled-thickness film. “Essentially” means that between 95% and 100% of the number of moles of the deficit reactant have reacted in the controlled-thickness film. These percentages can be combined together according to the chemical reaction considered. In the embodiments particularly involving cascade reactions, for example, the term “chemical reaction” includes all the reactions involved.

### DETAILED DESCRIPTION

The various technical criteria considered (reaction partners, spraying, etc.) are naturally applicable for all possible combinations.

Reaction Partners

Preferred embodiments of the present invention concerning the reaction partners are naturally applicable to other embodiments concerning the other technical criteria of the present invention.

One advantageous process according to the present invention concerns reaction partners leading to the product by chemical reaction.

Another advantageous process according to the present invention concerns reaction partners leading to the product by physical or physicochemical interaction.

Control of the Interaction Between the Reaction Partners

Preferred embodiments of the present invention concerning control of the interactions between the reaction partners are naturally applicable to other embodiments concerning the other technical criteria of the present invention.

Thus, according to the method of the present invention, the interaction between reaction partners is advantageously controlled by determination of at least one of the following adjustment parameters:
concentration of the reaction partners in each liquid and viscosity of each of the spraying liquids containing the reaction partners;
composition and nature of the solvent present in each of the liquids sprayed;
temperature of the sprayed liquids;
dimension, density, speed and polydispersity of the droplets according to the geometry and nature of the spray nozzles;
variation of the angles at the top of the spray jet dispersion cones;
distance between the nozzles and the surface on which the liquid reaction zone forms;
incline of said surface with regard to the main axis of the spray jets;
spray jet flow rate for the various liquids;
nature, temperature, flow rate and/or pressure of the carrier gas used for spraying;
nature of the substrate.

These characteristics are well known to the person skilled in the art who knows how to adjust them individually with regard to the other characteristics and according to the desired properties of the film in which the reactions occur.

Spraying

Preferred embodiments of the present invention concerning the spray criteria are naturally applicable to other embodiments concerning the other technical criteria of the present invention.

Simultaneous Spraying

According to the method of the invention, simultaneous spraying can be conducted to minimize collisions, contacts and/or coalescences of said reaction partners in the spray jets before contacting the surface bearing the liquid reaction zone.

It is possible in the method according to the invention, in addition to said simultaneous spray, to conduct an additional spray of a gas and/or additional dilution solvent and/or other liquid containing other products such as, for example, surfactants or catalysts.

Means for Controlling the Spray

Shape of the Spray Jets

The spray jets can have diverse and varied forms, for example solid or hollow cones, tighter or looser, according to the techniques for controlling sprays well known to the person skilled in the art.

Advantageously, according to the method of the invention, the spray nozzles used generate spray jets in the form of solid cones.

Positioning of a Movable Shutter

In the method according to the invention, the spray can be controlled by interposing a screen with an opening calibrated to select the central part of the spray jets and prevent contamination of the surface by the edges of the jets. The screen can be made of any type of material and in any possible form.

It may therefore be advantageous during spraying according to the method of the invention to interpose an additional screen between the nozzle(s) and the crossover point of the spray jets provided with at least one opening passing alternatingly in front of the spray jets to control the collisions and interactions of the sprayed droplets (FIG. 1).

Advantageously, the opening of the additional screen, between the nozzles and the crossover point of the spray jets, is calibrated.

The screen can be interposed between the nozzle(s) and the spray jet crossover point by any movement whatever.

Advantageously, the additional screen is interposed between the nozzle(s) and the crossover point of the spray jets by a rotating movement. The screen is therefore called rotary in this particular embodiment.

Advantageously, the additional screen is interposed between the nozzle(s) and the crossover point of the spray jets by a lateral linear movement on a system of runners, for example. The screen is therefore called linear in this particular embodiment.

It may also be advantageous during spraying according to the method of the invention to interpose an additional screen between the nozzle(s) and the crossover point of the spray jets.

Positioning of the Spray Jets

The spray devices (nozzle, sprayer, atomizer, etc.) are positioned so that the surface on which the liquid reaction zone forms is covered as best as possible, i.e., there are no “free” areas, which is to say areas not covered with the reaction liquid.

Thus, advantageously, according to the method of the invention, said nozzles are arranged so that the spray jets reach the surface on which the liquid reaction zone is formed along a direction primarily orthogonal to this surface.

Advantageously, the surface on which the liquid reaction zone is formed is called solid.

Advantageously, the liquid reaction zone forms a film in which the nanoscale material or materials are produced.

Of course, it is possible, although this is not the preferred embodiment of the present invention, for the film produced to have variations in thickness, exposing “free” areas not covered by the reaction liquid.

Film

The preferred embodiments of the present invention concerning the films obtained are naturally applicable to other embodiments concerning other technical criteria of the present invention.

In the present invention, the film comprises one or more solvent(s) and solutes, which are the reaction partners. The method according to the invention permits obtaining a film of controlled thickness comprised between around ten nanometers and several hundred micrometers. Advantageously, the method according to the invention permits obtaining a film with a thickness of 0.1 μm to 100 μm, advantageously between 0.2 and 50 μm, and more advantageously between 0.5 and 50 μm. Advantageously, the method according to the invention permits obtaining a film with a fairly constant thickness.

Moreover, in the method according to the invention, it is advantageous to blow an additional gas or liquid stream to control the homogeneity and thickness of the film making up the liquid reaction zone to improve mixing and film quality and to dilute the reaction zone.

Nanoscale Material

Preferred embodiments of the present invention concerning the nanoscale materials obtained are naturally applicable to other embodiments concerning the other technical criteria of the present invention.

As explained above, the nanoscale material can be obtained by chemical reaction or by physical or physicochemical interaction.

Chemical/Physicochemical Interactions

Advantageously, according to the method of the present invention, said reaction partners lead to a nanoscale material by chemical reaction.

Any physical or physico-chemical technique applicable in the case at hand and known to the person skilled in the art can be used, for example by complexing reactions or crystal nucleation, or even by physical transformation, such as the formation of an emulsion or precipitation of an amorphous or crystalline compound. Moreover, it is possible to induce a reaction by an additional manipulation which may consist of the use of laser technology, or even the use of strong magnetic and/or electrical fields, the piezoelectric effect, thermal radiation, ultrasound, the application of an electrospray, electrochemistry, electromagnetic radiation such as microwave radiation, infrared radiation, UV radiation, etc., for example.

It is also possible to use a gas like nitrogen or even an inert gas like argon in carrying out the method as either a carrier gas during spraying or simply in the chamber where the spraying is done, or both. It is also possible to deposit films according to the present invention under a reduced pressure atmosphere by using ultrasound or electrospray nozzles.

It is also possible to deposit films according to the present invention under vacuum by using ultrasound or electrospray nozzles, for example. Thus, according to a particular embodiment of the method of the present invention, said reaction partners lead to the nanoscale material by physicochemical interaction, such as complexation or crystal nucleation reactions, or even by physical transformation, such as the formation of an emulsion or precipitation of an amorphous or crystalline compound.

According to the method of the present invention, said reaction partners lead to the nanoscale material by chemical reaction or by physicochemical interaction, such as complexation or crystal nucleation reactions, or even by physical transformation, such as the formation of an emulsion or precipitation of an amorphous or crystalline compound.

Moreover, by the method of the present invention, it is advantageous for the solubility of the nanoscale material formed to be lower than the solubility of the reaction partners in their liquid spray solution. For example, in one particular embodiment of the method according to the invention, the nanoscale material can be obtained by precipitation of the product into solution in a solvent by contact with a non-solvent.

Adjustment Parameters of the Present Invention

According to the method of the present invention, formation of the nanoscale material is advantageously controlled by determination of at least one of the following adjustment parameters:
concentration of the reaction partners in each liquid and viscosity of each spray liquid containing the reaction partners;
composition and nature of the solvent present in each of the liquids sprayed;
temperature of the sprayed liquids; size, density, speed and polydispersity of the droplets according to the geometry and nature of the spray nozzles;
variation of the angles at the top of the spray jet dispersion cones;
distance between the nozzles and the surface on which the liquid reaction zone forms;
incline of said surface with regard to the main axis of the spray jets;
spray jet flow rate for the various liquids; nature, temperature, flow rate and/or pressure of the carrier gas used for spraying;
nature of the substrate.

These characteristics are well known to the person skilled in the art who knows how to adjust them individually with regard to the other characteristics and according to the desired properties of the film in which the reactions occur.

Recovery of the Nanoscale Material

Once the formation of the nanoscale material is established, it remains to recover said nanoscale material. This can be done in several ways; this is one of the advantages of the present invention, which allows extensive modularity of the recovery techniques. Since the method is done in a reactor that can be open, it is possible to use a broad range of techniques known to the person skilled in the art for recovering the nanoscale material. Of course, these recovery techniques for the nanoscale material or materials formed depend on the physicochemical state of the nanoscale products in the solvent or solvents containing them. Thus, in the particular embodiments of the method of the present invention, the nanoscale material is recovered in the form of a solution, suspension, or emulsion of nanoscale particles, or even complex dispersions, aggregates or composite materials, or even multicomposite nanoparticles.

In particular, one of the embodiments allows recovering the nanoscale material by drainage. Thus, in an advantageous manner according to the method of the present invention, the nanoscale material is recovered by draining, for example, from the liquid reaction zone, in particular via porous surfaces such as membranes.

Another embodiment according to the method of the present invention consists of recovering the nanoscale material by rotation of the liquid reaction zone. Thus, according to the method of the present invention, the nanoscale material is recovered by draining from the liquid reaction zone, in particular via porous surfaces such as membranes or by rotation of the liquid reaction zone.

Surface on which the Liquid Reaction Zone is Formed

Another aspect of the invention therefore concerns the solid surface on which the liquid reaction zone forms.

Preferred embodiments of the present invention concerning the surfaces on which the liquid reaction zone forms are naturally applicable to other embodiments concerning the other technical criteria of the present invention.

Thus, one particular embodiment according to the method of the present invention concerns the surface on which the liquid reaction zone is formed, which is an essentially flat surface.

Another particular embodiment according to the method of the present invention concerns the surface on which the liquid reaction zone is formed, which is a rough surface having rotational symmetry.

A rough surface is a non-developable ruled surface.

Another particular embodiment according to the method of the present invention concerns the surface on which the liquid reaction zone is formed, which is partially spherical.

And another particular embodiment according to the method of the present invention concerns the surface on which the liquid reaction zone is formed, which is partially ellipsoidal.

These various embodiments may be combined with one another. Thus, in the method according to the present invention, the surface on which the liquid reaction zone forms is mainly a flat and/or rough surface with rotational symmetry and/or a partially spherical surface and/or a partially ellipsoidal surface.

And in still another particular embodiment according to the method of the present invention, the surface on which the liquid reaction zone forms is nonporous, partially porous or porous in order to permit control and/or recovery of the nanoscale material (variation and control of the density and size of the pores).

In one particular embodiment according to the method of the present invention, the surface on which the liquid reaction zone is formed is fixed with regard to the spray nozzles.

In another particular embodiment according to the method of the present invention, the surface on which the liquid reaction zone is formed is mobile in rotation with regard to the main axis substantially orthogonal to said surface.

Thus, according to the method of the present invention, the surface on which the liquid reaction zone is formed is fixed with regard to said spray nozzles or mobile in rotation with regard to a main axis substantially orthogonal to said surface.

“Substantially” means that the variation of the angle of the main axis orthogonal to the surface on which the liquid reaction zone is formed is comprised between 0° and 10°, advantageously between 0 and 5°.

In one particular embodiment, the method of the present invention is characterized in that the functional surface on which the liquid reaction zone is formed is made of a non-adhesive material such as PTFE or PE, which may or may not be wettable by the liquid of the film or the sprayed droplets that reach said surface. Advantageously, the functional surface on which the liquid reaction zone is formed is of the antifouling, catalytic type, and/or may be stirred by ultrasound, etc.

In one particular embodiment, the method of the present invention is conducted under ambient atmosphere or in a reactor with an inert gas atmosphere.

In another embodiment, the method of the present invention is conducted in a reactor with an oxidizing, reducing or reactive gas atmosphere.

Thus, the method according to the present invention is conducted under ambient atmosphere or in a reactor with an inert gas atmosphere or in a reactor with an oxidizing, reducing or reactive gas atmosphere.

REACTOR Itself

Another subject of this invention concerns a reactor. The reactor according to the present invention permits implementing the method described above.

Preferred embodiments of the present invention concerning the reactor are naturally applicable to other embodiments concerning the other technical criteria of the present invention.

The reactor according to the present invention comprises at least two sprayers each fed by a liquid and whose spray nozzles converge in the direction of a plate intercepting the sprayed liquid reactant jets, and in that the arrangement of the sprayers with regard to each other and to said plate is such that the sprayed liquid reactant jets completely or partially overlap on the surface of said plate to form a liquid reaction zone in the form of a homogenous film of controlled thickness.

Positioning of the Plate

Preferred embodiments of the present invention concerning the positioning of the plate are naturally applicable to other embodiments concerning the other technical criteria of the present invention.

Said plate, onto which the liquid reactant jets are sprayed, may be positioned and oriented in any manner so as to conduct the method described above. Very advantageously, said plate is positioned vertically so that the reaction liquid and/or the nanoscale material flows as the spray proceeds according to the method of the present invention. Said plate may also be inclined to a greater or lesser degree relative to the vertical.

The variations of these inclines depend on spraying factors and/or the formation of nanoparticles.

Advantageously, said plate is inclined slightly relative to the vertical axis for fast reactions or possibly those not requiring additional treatment, i.e., an angle comprised between 0° and 45° relative to the vertical axis.

Advantageously, said plate is inclined slightly relative to the horizontal axis for slow reactions or those requiring additional treatment (for example, by laser technology), i.e., an angle comprised between 0° and 45° with regard to the horizontal axis. Naturally, the inclination is determined in each case by the person skilled in the art, who will know how to assess the development according to the criteria of the targeted synthesis.

Recovery of the Nanoscale Material

Preferred embodiments of the present invention concerning recovery of the nanoscale material are naturally applicable to other embodiments concerning the other technical criteria of the present invention.

Thus, advantageously, the reactor according to the present invention also contains, in the immediate neighborhood of said plate, means for recovering the nanoscale material.

In one particular embodiment, said recovery means in the reactor according to the present invention are means for recovery by drainage.

In another particular embodiment, said recovery means in the reactor according to the present invention are means for recovery by centrifugation.

Surface on which the Liquid Reaction Zone is Formed

Preferred embodiments of the present invention concerning the surface on which the liquid reaction zone forms are naturally applicable to other embodiments concerning the other technical criteria of the present invention.

Moreover, in one particular embodiment, in the reactor according to the present invention, the surface on which the liquid reaction zone is formed is an essentially flat surface.

In another particular embodiment, in the reactor according to the present invention, said surface on which the liquid reaction zone is formed is a rough surface having rotational symmetry.

In yet another particular embodiment, in the reactor according to the present invention, said the surface on which the liquid reaction zone is formed is partially spherical.

And again in another preferred embodiment, in the reactor according to the present invention, said surface on which the liquid reaction zone forms is partially ellipsoidal.

In another particular embodiment, in the reactor according to the present invention, the surface of the plate is made of a non-adhesive material, such as PTFE or PE.

Spraying

Preferred embodiments of the present invention concerning spraying are naturally applicable to other embodiments concerning the other technical criteria of the present invention.

The spraying done in the reactor permits implementing the method described above. Thus, the reactor contains the sprayers defined above.

The spray jets can have diverse and varied forms, for example solid or hollow cones, tighter or looser, according to the techniques for controlling sprays well known to the person skilled in the art.

Advantageously, in a reactor according to the present invention, the spray nozzles are chosen so as to generate solid spray cones.

Moreover, in one preferred embodiment of the reactor according to the present invention, a screen provided with a calibrated opening is interposed between said spray nozzles and said plate, so as to select the central part of the spray jets and prevent the contamination of the surface by the edges of the jets. It may be advantageous during spraying according to the method of the invention to add a rotating screen between the nozzle(s) and the crossover point of the spray jets provided with at least one opening going alternatingly in front of the spray jets to control the collisions and interactions of the sprayed droplets (FIG. 1).

The spray devices (nozzle, sprayer, atomizer, etc.) are positioned so that the surface on which the liquid reaction zone is formed is covered as best as possible, i.e., there are no “free” areas, that is to say, areas not covered with the reaction liquid.

Of course, it is possible, although this is not the preferred embodiment of the present invention, for the film produced to have variations in thickness, exposing “free” areas not covered by the reaction liquid.

Advantageously, in the reactor according to the present invention, the spray nozzles are arranged so that the spray jets contact said plate along a direction substantially orthogonal relative to the plate.

Moreover, in one particular embodiment, the reactor according to the present invention also comprises, upstream of the sprayers, means permitting varying the reactant concentration of the liquids to be sprayed so as to control the progress of the reaction of forming the nanoscale material.

Means for varying the reactant concentration in the liquids to be sprayed work by techniques well known to the person skilled in the art to modulate the solution concentrations, for example by dilution, which can be done, for example, in a succession of tanks before spraying.

Moreover, in one particular embodiment of the reactor according to the present invention, an additional sprayer bringing a flow of additional gas is directed toward the plate so as to control the homogeneity and thickness of the film that makes up the liquid reaction zone.

Advantageously, the reactor according to the present invention also contains, in the immediate area of said plate, additional spray means for generating blowing in the peripheral areas of the liquid reaction zone so as to eliminate excess thickness of liquid in the periphery of said plate.

It is possible to have several air jets permitting controlling the thickness/homogeneity of the film.

Thus, in one particular embodiment of the reactor according to the present invention, an additional sprayer bringing an additional stream of gas is directed toward said plate so as to control the homogeneity and thickness of the film constituting the liquid reaction zone, and/or in the immediate neighborhood of said plate, additional spray means for generating blowing in the peripheral areas of the liquid reaction zone in order to eliminate excess thickness of liquid at the periphery of said plate.

For example, in the case of sprayers, the operating conditions of the present invention are comprised within the following minimum and maximum value ranges:
gas pressure: between 0.05 and 15 bars
nozzle/plate distance: between 0.5 cm and 1 m;
liquid flow: between 0.01 mL/min and 5 L/min.

These criteria are well known to the person skilled in the art, who knows how to apply them wisely. For example, it is well known that sprayers of the electrospray type and ultrasound sprayers can operate at reduced pressure or under vacuum and that that there is then little or no gas pressure.

Specific Details that can be Added

Preferred embodiments of the present invention concerning the specific details that can be added are naturally applicable to other embodiments concerning the other technical criteria of the present invention.

As explained above, one of the key points of the present invention is the great modularity of the reactor and the method described.

For example, the reactor according to the present invention can be made up of a closed or open chamber.

In one particular embodiment, the reactor according to the invention is made up of a closed chamber in which there is a controlled gas atmosphere.

Thus, the present invention permits the use of any gas at a desired pressure. It is thus possible to vary the environment during mixing according to the present invention, so as to be, for example, in an oxidizing, reducing or inert environment. Advantageously, the gas is an inert gas like argon.

In addition, one of the undeniable advantages of the present invention is the fact that in one particular embodiment, it can be a continuously operating reactor.

Continuous operation means that spraying is not stopped while the method is being implemented. Thus, film renewal is not interrupted during the formation of the desired nanoscale material, in the desired quantity.

### LEGEND OF THE FIGURES

FIG. 1 describes a profile view of one embodiment of spraying according to the present invention.

FIG. 2 is a graph showing the intensity count of several mixtures of two reaction partners (PAH and DNA) depending on their ratio.

FIG. 3 is a photograph of 3 tanks containing distinct solutions/suspensions of ascorbic acid and HAuCl₄ (molar ratios in ascorbic acid:HAuCl₄ of 1:4, 1:2 and 1:1) obtained according to the spraying of the present invention. The solution of the left tank is colorless and translucent, that of the center tank is translucent blue, and that of the right tank is translucent pink.

FIGS. 4 and 5 are a photograph of 10 tanks containing solutions/suspensions obtained from ascorbic acid and HAuCl₄ (respective molar ratios from left to right of the “ascorbic acid:HAuCl₄” mixtures: 1:10, 1:9, 1:8, 1:7, 1:6, 1:5, 1:4, 1:3, 1:2 et 1:1) by hand mixing (FIG. 4) and by this invention (FIG. 5). A variation of the colors of the solutions contained in the tanks represented shows a control of the reaction in the case of solutions obtained by the present invention: the solutions of the tanks of FIG. 4 have disparate colors, while the solutions of the tanks of FIG. 5 are more homogenous and representative of the “ascorbic acid:HAuCl₄” ratios, which implies different particle sizes and aggregation in each case.

FIG. 6 is a graph representing the variation of particle size in accordance with the ratio of the volumes of ascorbic acid and HAuCl₄ delivered (described in FIGS. 4 and 5) obtained by hand mixing and by the present invention, respectively.

FIG. 7 is a graph representing the variation of particle size in accordance with the volumes of ascorbic acid and HAuCl₄ delivered (described in FIGS. 4 and 5) obtained by the present invention at different times of recovering the solution by drainage (30 seconds, 1 minute and 2 minutes).

FIGS. 8, 9 and 10 are photographs of the 3 tanks containing the 3 separate solutions/emulsions obtained according to the spraying of the present invention or by conventional techniques with approximate latency times between obtaining the solutions and the photograph of tₐₚₚᵣₒₓ=0 hours, 3 hours and 24 hours, respectively.

FIG. 11 is a photograph of a plate that has been sprayed according to the present invention. The spray arrives on the right. The spraying axis is centered on the silicon plate. Liquid flow rate=25 mL/min±5 mL/min. Gas flow rate=60 L/min±10 L/min. Nozzle-plate distance=18 cm±5 cm. The liquid is pressed back onto the edges of the substrate by the incoming stream of air and thus forms a bulge on the edge of said substrate.

FIG. 12 is a schematic representation (left) and photograph (right) of the chamber used to work under inert atmosphere

FIG. 13 shows two tanks representing the products obtained by the present invention in the absence (a) and presence (b) of oxygen from a mixture of salts and iron (II and II) and a sodium hydroxide solution.

FIG. 14 shows the magnetic properties of the magnetite particles obtained by the present invention by means of a magnet.

FIG. 15 shows two tanks representing the products obtained by the present invention in the absence (a) and presence (b) of oxygen from iron sulfate and a sodium hydroxide solution containing a stabilizing agent (sodium phytate). The oxidized solution takes on an orange color, while the non-oxidized one is green. Thus, exposing the tank containing the green solution to air induces progressive discoloration of the solution by its surface in contact with the air, ruled by the laws of diffusion.

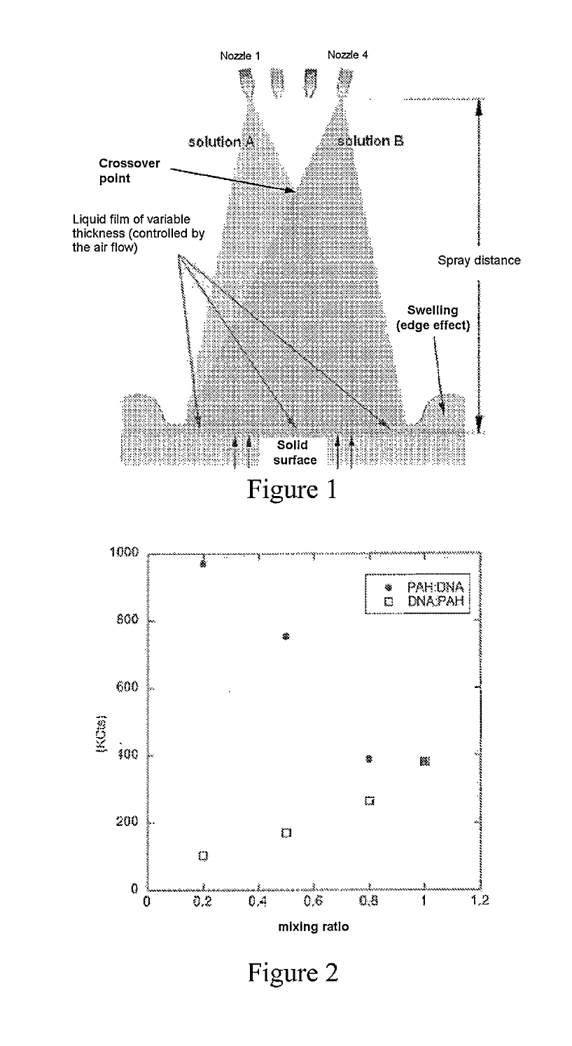

The present invention is described in more detail by means of the following examples, which are given by way of illustration, and to which the invention is not limited.

### EXAMPLES

Note: In the following examples, if the solvent is not specified, it is water.

Additional information on the operating conditions used in the various examples:
gas pressure: between 1 and 5 bars;
nozzle/plate distance: between 8 and 35 cm;
liquid flow: between 1 mL/min and 20 L/min.

Of course, these three parameters must be adjusted to obtain the optimal conditions for formation of the desired materials.

Spray deposition using “Air Boy” compressed air sprayers give interesting results in the case of conventional alternating sprays of multiple layers of polyelectrolytes (see Izquierdo et al., Langmuir, 2005, or Zhiquiang et al., CRAS 2009).

The authors of the present invention have also used this type of device in simultaneous sprays of multiple polyelectrolyte layers (see C. H. Porcel et al., Langmuir 2005). However, this type of device called “single component nozzle” and which operates without an inert carrier gas stream, for example, only allows conclusively simultaneously spraying multiple polyelectrolyte layers in one example reported in the above-mentioned article.

The invention presented here concerns devices with “multiple component nozzles” in which the liquid droplets are formed in an air flow or any other type of nozzle for spraying (electrospray, ultrasound, micro-nozzle, atomizer, nebulizer, ink jet printing, piezoelectric, etc.).

For example, a flow of gas through the nozzle or another part of the device is essential in the embodiments of the following examples. At present, the type of device used permits precisely controlling the gas pressure applied and thus the flow rate of gas and liquid sprayed. For example, effective pumps in the implementation of the device of the invention are M50 liquid delivery pumps from VICI, Switzerland. The advantage of using this type of device is the possibility of performing continuous spraying. All the examples described in this invention can be conducted by the use of a device for precise control of all the spraying parameters, whether using a pump or not.

### Example 1

### Comparison Between Traditional Mixing and Mixing According to the Method of the Present Invention

Tests were conducted for four different systems comprising an anionic constitute and a cationic constituent in each case:
(a) 1 mg/mL polyallylamine hydrochloride (PAH) (molecular weight of 56 K) and 0.45 mg/mL polystyrene sulfonate (PSS, molecular weight of 70 K).
(b) 6.4 mM (Ca(NO₃)₂.H₂O for Ca²⁺ and 3.8 mM (NH₄)₂HPO₄ for HPO₄²⁻.
(c) 1 mg/mL of polyallylamine hydrochloride (PAH) (molecular weight of 56 K) and 0.3 mg/mL of deoxyribonucleic acid (DNA, molecular weight of 50-100 K).
(d) 0.014 mg/mL of polyallylamine hydrochloride (PAH) (molecular weight 56 K) and 1 mg/ml of bovine serum albumin (BSA, molecular weight 66 K).

So-called traditional mixing experiments have been conducted as follows: 5 mL of cationic solution were rapidly added to 5 mL of an anionic solution with magnetic stirring. The resulting solution/suspension/emulsion was mixed for five minutes, followed by intensity counting measurements by light scattering (Malvern, Zetasizer). Solutions/suspensions/emulsions obtained by reverse addition of cationic/anionic solutions were made in the same way.

The same solutions were used in the method of mixing by simultaneous spraying of two solutions (compressed air flow rate of 30 mL/min, liquid flow rate of 10 mL/min, nozzle-plate distance 25 cm). The solutions were sprayed simultaneously at the center of a plate positioned vertically. One to two millimetres of each mixture were collected at the base of the plate, followed by light scattering photon counting measurements (Malvern, Zetasizer), like for so-called traditional mixing experiments.

The results are collected in Table 1:

| | Mixing | | | | |
|---|---|---|---|---|---|
| | constituents | | Count rate (KCts) | | |
| | A | B | | | spraying |
| Experiments | (+) | (−) | A in B | B in A | A and B |
| (a) | PAH | PSS | 187.0 | 864.8 | 376.1 |
| (b) | Ca | P | 1478.7 | 1321.0 | 1012.6 |
| (c) | PAH | DNA | 435.1 | 80.3 | 380.2 |
| (d) | PAH | BSA | 1772.2 | 2012.9 | 1707.0 |

In this series of results, the count rate shows that the products obtained by either technique are very different. The table shows that we have access to chemical species other than those obtained by conventional mixing. Moreover, we can obtain these different products continuously.

### Example 2

### Effects of Changing the Mixing Ratios with the Technique According to the Invention

Mixtures of 1 mg/mL polyallylamine hydrochloride (PAH, molecular weight of 56 K) and 0.3 mg/mL deoxyribonucleic acid (DNA, molecular weight of 50-100 K) were used as the stock solution to do the experiments for measuring the effect of changing the mixing ratios of one of the two compounds with the technique according to the invention. Two series of experiments were conducted so that one of the two compounds is diluted to give mixing ratios of 0.2, 0.5 and 0.8 at a constant concentration of the other mixing compound. Solutions at each mixing ratio were sprayed simultaneously onto each vertical plate in a centered way on the surface of said plate (compressed air flow rate of 30 mL/min, liquid flow rate ranging from 2 to 10 mL/min, nozzle-plate distance 25 cm). The mixtures were recovered at the bottom of said plate at each spray for analysis by scattered-light diffusion intensity counting. See FIG. 2 for the results.

Conclusion: The graph clearly shows the control of the synthesis of the different materials in a continuous reactor.

### Example 3

### Synthesis of Gold Nanoparticles by Reduction with Ascorbate by Mixing According to the Method of the Present Invention

Ascorbic acid solutions of 1 mM, 0.5 mM, and 0.25 mM were prepared. A 1 mM solution of HAuCl₄ in water was also prepared. Both solutions were sprayed simultaneously onto a plate positioned vertically (compressed air pressure of 3 bars, liquid delivered by gravity, nozzle-plate distance of 25 cm). The solutions formed are each recovered at the base of said plate.

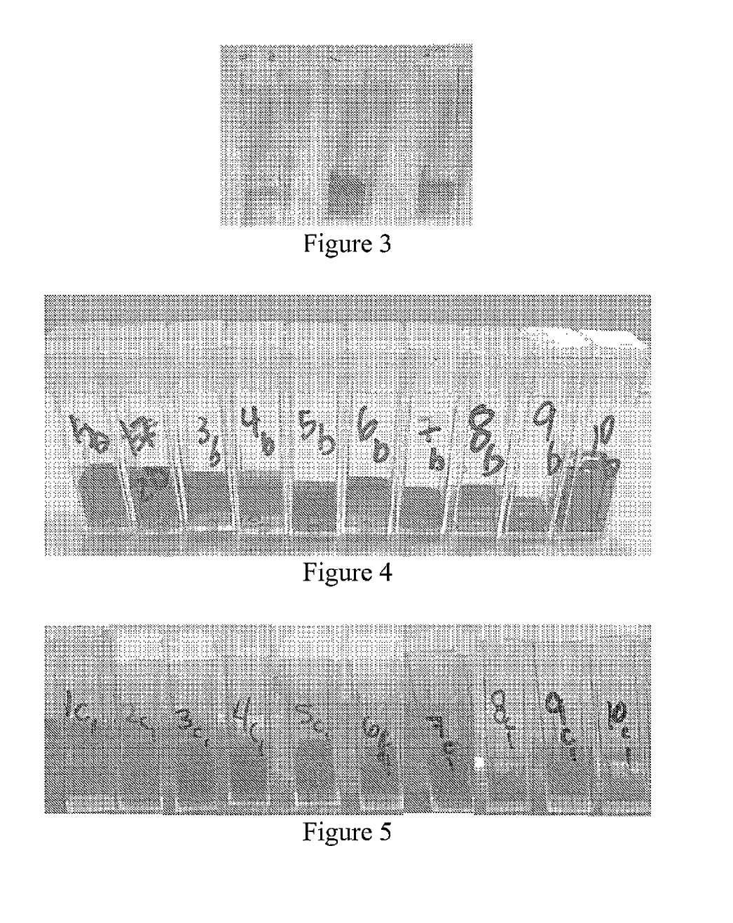

FIG. 3 shows the products obtained by mixing a solution of HAuCl₄ at a concentration of 1 mM and solutions of ascorbates of (a) 0.25 mM (excess Au), (b) 0.5 mM (excess ascorbate), and (c) 1 mM (equal Au and ascorbate).

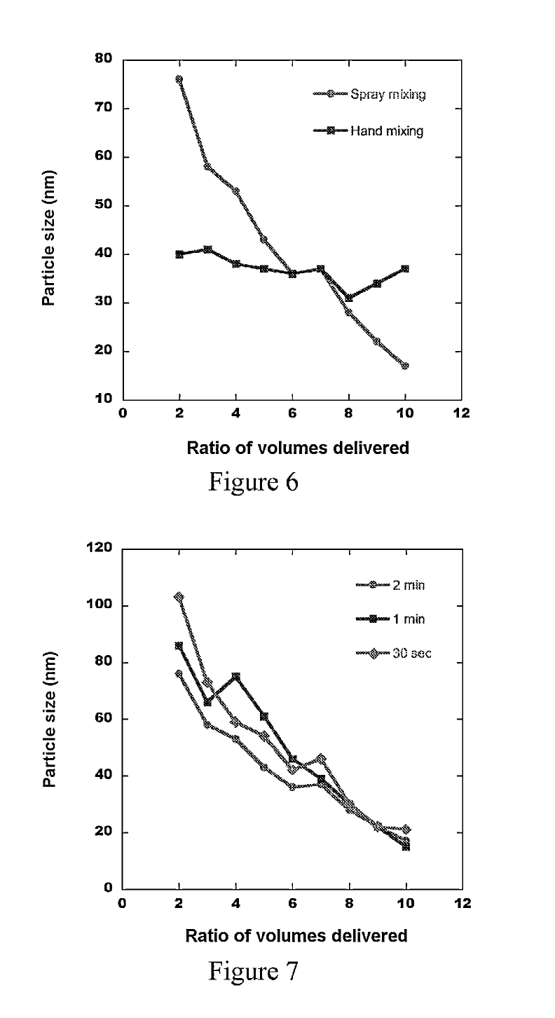

The various colors of the suspensions formed show the formation of nanoparticles of different sizes, control permitted by the method according to the invention. Additional studies were conducted from a 5 mM ascorbic acid solution and a 0.5 mM HAuCl₄ solution. In these experiments, the flow rates of liquid delivered for the ascorbic acid and HAuCl₄ are varied. It has been shown that different products were formed depending on these variations. One example of these variations in the ratio of liquid volumes delivered is shown in FIG. 4 for hand mixing and in FIG. 5 for mixing by simultaneous spraying (nitrogen pressure of 3 bars, total flow rate of the liquid delivered by both pumps is 20 mL/min, plate/nozzle distance 25 cm). In these two cases, the molar ratios of ascorbic acid and HAuCl₄ (“ascorbic acid:HAuCl₄”) delivered are respectively, from left to right, 1:10, 1:9, 1:8, 1:7, 1:6, 1:5, 1:4, 1:3, 1:2 and 1:1. The size of the particles obtained for each ascorbic acid/HAuCl₄ ratio was determined in both cases by means of a centrifugal particle size analyzer (CPS Instruments Inc.). FIG. 6 clearly shows particle size control according to the ratio of the reaction partners by the present invention while the particle size remains substantially the same regardless of the ascorbic acid/HAuCl₄ ratio by hand mixing. Moreover, the particle size was measured for the different ratios after 30 seconds, 1 minute and 2 minutes of spray (FIG. 7). The similar behavior observed in the three cases shows the capacity of the present invention to produce continuously controlled particle sizes.

### Example 4

### Formation of Stable Emulsions by Simultaneous Spraying of Aqueous and Organic Phases

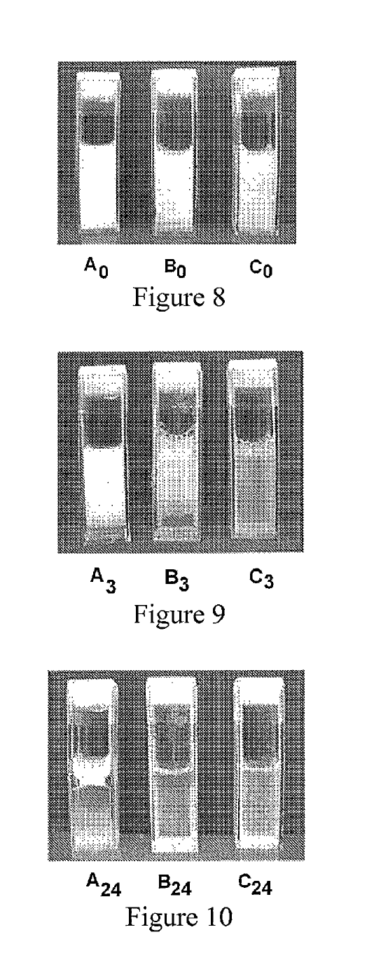

FIGS. 8, 9 and 10 represent the results obtained with regard to the destabilization time of emulsions (surfactants, cyclohexane and water) after their preparation. The surfactant used in these experiments was Rhodafac RA-600. The solutions shown in FIG. 8 were obtained directly after preparation of the emulsions, that is at tₐₚₚᵣₒₓ=0 (tₐₚₚᵣₒₓ being approximate time). The solutions of FIG. 9 are solutions obtained at tₐₚₚᵣₒₓ=3 hours. Finally, the solutions of FIG. 10 are solutions obtained at tₐₚₚᵣₒₓ=24 hours.

In each figure, tank A (i.e., A₀, A₃ and A₂₄, with the index 0, 3 or 24 hours representing tₐₚₚᵣₒₓ) and tank B (i.e., B₀, B₃ and B₂₄, with the index 0, 3 or 24 hours representing tₐₚₚᵣₒₓ) are tanks containing emulsions made conventionally and tank C (i.e., C₀, C₃ and C₂₄, with the index 0, 3 or 24 hours representing tₐₚₚᵣₒₓ) contain an emulsion made by spraying according to the method of the present invention (compressed air of 3 bars, liquid delivered by gravity, nozzle/plate distance of 25 cm). The so-called “conventional” emulsion of tank A and the emulsion of tank C were made from identical solutions. However, the inventors realized that a significant portion of the organic solvent evaporated during spraying. Thus, the composition of the so-called “sprayed” emulsion is different from the stoichiometry of sprayed mixtures. Tank B of each image therefore is an emulsion prepared conventionally with a composition similar to that of tank C.

It is clear that according to these figures, the emulsion made by spraying is more stable than the emulsions obtained conventionally. This effect is reproducible, although the inventors cannot currently explain it. These results show an improvement of the stability of the emulsions and prove the concept of preparation of emulsions in a continuous manner.

### Example 5

Synthesis of magnetic particles by simultaneous spraying of a solution containing a mixture of iron II (0.1 M) and iron III (0.2 M) salts and a sodium hydroxide solution at 0.5 M (equation 1). The size of the particles (nanometric to micrometric) is set by the concentrations used for the reaction partners in the present invention. In this example, relatively high concentrations were used for a macroscopic visualization of particles and their magnetic property. However, the present invention also permits synthesis of nanoparticles. In all cases, the reaction must be conducted in the absence of oxygen to prevent oxidation of the magnetite formed (Fe₃O₄) and a non-magnetic product, iron III hydroxide (Fe(OH)₃) (equation 2).

Fe²⁺2Fe³⁺+8.OH⁻→Fe₃O₄+4.H₂O equation 1

Fe₃O₄+0.25.O₂+4.5.H₂O→3.Fe(OH)₃ equation 2

A control experiment was conducted in the presence (ambient air) and absence (nitrogen) of oxygen to verify the oxidation phenomenon under the experimental conditions of the present invention.

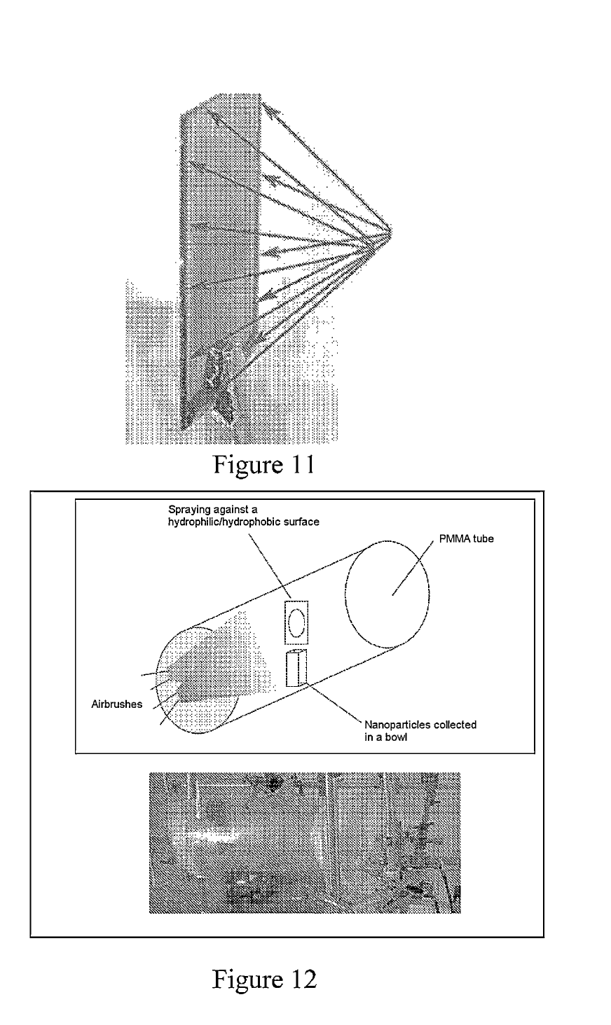

Simultaneous spraying (nitrogen pressure of 3 bars, liquid flow rate of 10 mL/min and airbrush/substrate distance of 30 cm) was therefore done in a closed chamber, a transparent PMMA (poly(methyl methacrylate)) tube 25 cm in diameter and cm long, optionally purged with nitrogen (FIG. 12).

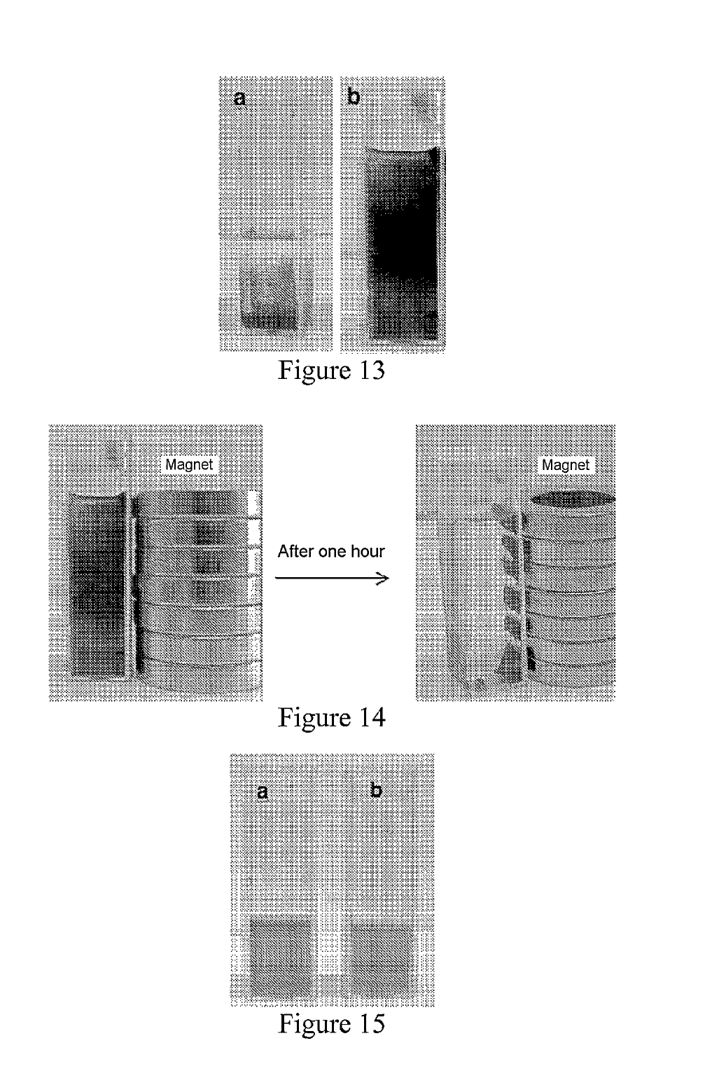

FIG. 13 shows the formation of solid Fe(OH)₃, red/orange in color, in the presence of oxygen, while particles of brown/black magnetite are obtained in the absence of oxygen. The magnetic properties of Fe₃O₄ particles were confirmed by placing a magnet on the side of the tank containing them (FIG. 14). Thus, the particles attracted by the magnet are found after 1 h on the wall of the tank where the magnet is located.

Another example of the synthesis of particles based on iron II and iron III confirmed the need to work under inert atmosphere for this type of synthesis. This synthesis was conducted by simultaneous spraying (nitrogen pressure of 3 bars, iron solution flow rate: 10 mL/min, base solution flow rate: 5 mL/min airbrush/substrate distance of 20 cm,) of an iron II solution (FeSO₄.7H₂O, 10 mM) and a sodium hydroxide solution (0.1 M) containing a stabilizer (sodium phytate, 4 mM). FIG. 15 shows the formation of iron hydroxide particles (II and II) in the absence of oxygen (green solution), while in the presence of oxygen, iron III hydroxide is obtained (brown-orange solution).

These two examples show that the present invention permits obtaining magnetic particles in a controlled and continuous manner.

1. A method for producing a nanometric to micrometric size material from at least two reaction partners, characterized in that it involves simultaneously spraying at least two clouds of droplets of micrometric or nanometric size, each containing one of said reaction partners that are precursors of said material or a mixture thereof, through nozzles convergent in the direction of a solid surface on which is formed, by overlay of sprayed liquid jets, a homogenous liquid reaction zone in the form of a film of controlled thickness comprised between 0.1 μm and 100 μm inside of which the reaction leading to said nanometric material mainly occurs.

2. The method according to claim 1, characterized in that said reaction partners lead to the nanoscale material by chemical reaction or by physicochemical interaction, such as complexation or crystal nucleation reactions, or even by physical transformation, such as the formation of an emulsion or precipitation of an amorphous or crystalline compound.

3. The method according to claim 1, characterized in that the surface on which the liquid reaction zone forms is substantially a flat and/or rough surface with rotational symmetry and/or a partially spherical surface and/or a partially ellipsoidal surface.

4. The method according to claim 1, characterized in that the surface on which the liquid reaction zone forms is non-porous, partially porous or porous in order to allow control and/or recovery of the nanometric material.

5. The method according to claim 1, characterized in that the surface on which the liquid reaction zone is formed is fixed with regard to said spray nozzles or mobile in rotation with regard to a main axis substantially orthogonal to said surface.

6. The method according to claim 1, characterized in that the spray can be controlled by interposing a screen with an opening calibrated to select the central part of the spray jets and prevent contamination of the surface by the edges of the jets.

7. The method according to claim 1, characterized in that an additional screen is interposed between the nozzle(s) and the crossover point of the spray jets provided with at least one opening going alternatingly in front of the spray jets to control the collisions and interactions of the sprayed droplets.

8. The method according to claim 1, characterized in that the solubility of the nanoscale material formed is lower than the solubility of the reaction partners in their liquid solution for spraying, for example by precipitation of the product in solution in a solvent by contact with a non-solvent.

9. The method according to claim 1, characterized in that the formation reaction of the nanoscale material is advantageously controlled by determination of at least one of the following adjustment parameters:
concentration of the reaction partners in each liquid and viscosity of each of the spraying liquids containing the reaction partners;
composition and nature of the solvent present in each of the liquids sprayed;
temperature of the sprayed liquids;
dimension, density, speed and polydispersity of the droplets according to the geometry and nature of the spray nozzles;
variation of the angles at the top of the spray jet dispersion cones;
distance between the nozzles and the surface on which the liquid reaction zone forms;
incline of said surface with regard to the main axis of the spray jets;
spray jet flow rate for the various liquids;
nature, temperature, flow rate and/or pressure of the carrier gas used for spraying;
nature of the substrate.

10. The method according to claim 1, characterized in that the functional surface on which the liquid reaction zone is formed is made of a non-adhesive material such as PTFE or PE, which may or may not be wettable by the liquid of the film or the sprayed droplets that reach said surface, advantageously the functional surface on which the liquid reaction zone forms is of the antifouling, catalytic type and/or can be stirred by ultrasound.

11. The method according to claim 1, characterized in that it is conducted under ambient atmosphere or in a reactor with an inert gas atmosphere or in a reactor with an oxidizing, reducing or reactive gas atmosphere.

12. The method according to claim 1, characterized in that, in addition to said simultaneous spray, an additional spray of a gas and/or additional dilution solvent and/or other liquid containing other products such as, for example, surfactants or catalysts is conducted.

13. The method according to claim 1, characterized in that an additional gas or liquid stream is blown to control the homogeneity and thickness of the film making up the liquid reaction zone to improve mixing and the quality of the film and to dilute the reaction zone.

14. The method according to claim 1, characterized in that the nanoscale material is recovered by draining from the liquid reaction zone, in particular via porous surfaces such as membranes or by rotation of the liquid reaction zone.

15. The method according to claim 1, characterized in that said nozzles are arranged so that the spray jets reach the surface on which the liquid reaction zone is formed along a direction essentially orthogonal to this surface.

16. The method according to claim 1, further characterized in that the nanoscale material is recovered in the form of a solution, suspension or emulsion of nanoscale particles, or even complex dispersions, aggregates or composite materials, or even multicomposite nanoparticles.

17. A reactor for the production of nanoscale materials conforming to the method according to claim 1, characterized in that it comprises at least two sprayers each fed by a liquid and whose spray nozzles converge in the direction of a plate intercepting the sprayed liquid reactant jets, and in that the arrangement of the sprayers with regard to each other and to said plate is such that the sprayed liquid reactant jets completely or partially overlap on the surface of said plate to form a liquid reaction zone in the form of a homogenous film of controlled thickness, preferably continuously operating.

18. The reactor according to claim 17, characterized in that it also contains an additional sprayer bringing an additional flow of gas directed toward said plate so as to control the homogeneity and thickness of the film constituting the liquid reaction zone, and/or in the immediate neighborhood of said plate, additional spray means for generating blowing in the peripheral areas of the liquid reaction zone in order to eliminate excess thickness of liquid at the periphery of said plate.

19. The reactor according to claim 17, characterized in that it also comprises, upstream of the sprayers, means permitting varying the reactant concentration of the liquids to be sprayed so as to control the progress of the reaction of forming the nanoscale material.
